(19) United States
(12) Patent Application Publication
(10) Pub. No.: US 2021/0387749 A1
(43) Pub. Date: Dec. 16, 2021

(54) MODULAR SPACE STATION

(71) Applicant: BLOXTON INVESTMENT GROUP, LLC, Havertown, PA (US)

(72) Inventor: Michael Bloxton, San Diego, CA (US)

(73) Assignee: Nebula Space Enterprise, Inc, San Diego, CA (US)

(21) Appl. No.: 17/283,780

(22) PCT Filed: Oct. 11, 2019
(86) PCT No.: PCT/US19/55914

§ 371 Date: Apr. 8, 2021

Related U.S. Application Data
(60) Provisional application No. 62/853,098, filed on May 27, 2019.
(60) Provisional application No. 62/744,181, filed on Oct. 11, 2018.

(51) Int. Cl. B64G 1/10; B64G 1/64; B64G 1/12

(52) U.S. Cl. CPC B64G 1/10; B64G 1/641; B64G 2001/1064; B64G 2001/1092; B64G 1/12

(57) ABSTRACT

A space station includes: a core with multiple connected core pods; a ring with multiple connected ring pods; at least one shaft connecting the core and the ring, the at least one shaft including multiple connected shaft pods. The core pods are substantially identical to one another, the ring pods are substantially identical to one another, and the shaft pods are substantially identical to one another.

### BACKGROUND

One of the hurdles for humans to leave earth orbit or establish attractive habitats off-planet even in orbit, is that we have long been limited to small payload size. For example, the current largest payload that can be carried to geostationary transfer orbit is about 27,000 kg by the SpaceX Falcon Heavy, which famously carried a Tesla Roadster to space on its maiden voyage.

The fairing that sits atop the Falcon Heavy second stage, carries its payload and in size measures 13.1 meters high and 5.2 meters wide. The interior payload volume is reduced by the fairing's interior structure.

The Falcon Heavy can carry twice as much payload as any rocket currently in use and is only exceeded in its payload by the Saturn V rocket, last launched in 1973. And despite its large size, comparing it to the Delta IV Heavy, the Falcon Heavy lifts twice as much payload for 60% of the cost—and unlike the Delta IV Heavy, the Falcon Heavy is reusable.

But the Falcon Heavy will not hold its title for long. Whether it's China with its Long March 9, or SpaceX's BFR with its capacity of 330,000 kg, payload sizes are poised to take an enormous leap in possibility. And following the BFR's specifications, it has a cargo volume of 825 m3 with a diameter of 9 m and a length of about 48 m, not all of which is usable for cargo, but it still allows for the ability to move large items to space.

And launching from Earth's surface is only getting cheaper. The private space sector's most significant contribution in the last 40 years has been in lowering the launch costs that limit many space activities. Since 1981, the cost of space exploration has dropped from ˜$85,000/kg to ˜$950/kg, making large-scale space programs within the reach of both public and private enterprises. The Falcon Heavy Rocket alone can lift the equivalent to 8,000 gallons of water to low-earth-orbit (LEO) for just $90M USD, a feat that cost ˜$1.8B during the development of the International Space Station.

With this next phase in getting larger objects to space come new challenges, such as: What will we do with this added capacity? Building a moon base and preparing for a mission to Mars have garnered a lot of discussion. But in reality, for a long time, the vast majority of humanity will be stuck on the third planet from Sol, and for those wanting to visit space, or with a vision for projects that can be achieved in low and no gravity environments, the most realistic option will be to work on a space station, or operate high energy and heat producing apparatuses like servers on such a station.

### SUMMARY OF THE EMBODIMENTS

A space station includes: a core with multiple connected core pods; a ring with multiple connected ring pods; at least one shaft connecting the core and the ring, the at least one shaft including multiple connected shaft pods; wherein the core pods are substantially identical to one another, the ring pods are substantially identical to one another, and the shaft pods are substantially identical to one another.

### BRIEF DESCRIPTION OF THE DRAWINGS

The figures attached hereto describe the invention, and elements thereof.

FIGS. 1A and 1B show different views of the entire space station.

FIGS. 2A, 2B, and 2C show different views of the core pod.

FIGS. 3A, 3B, 3C, and 3D show different views of a shaft pod, with FIGS. 3B and 3C showing partial cutaways to reveal their interior.

FIGS. 4A, 4B, 4C, and 4D show multiple views of ring pods.

FIGS. 5A-5E show different views of the ring wedges.

FIGS. 6A and 6B show shaft connectors.

FIG. 7 shows a core connector.

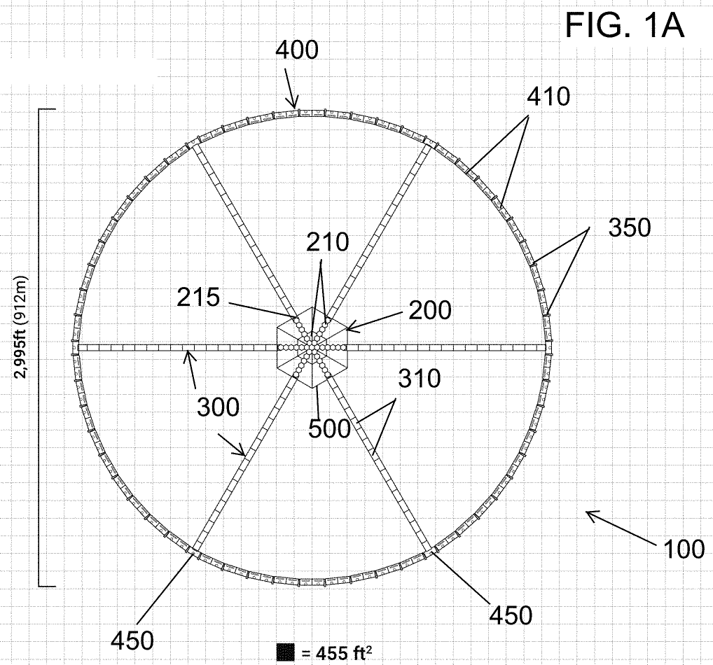

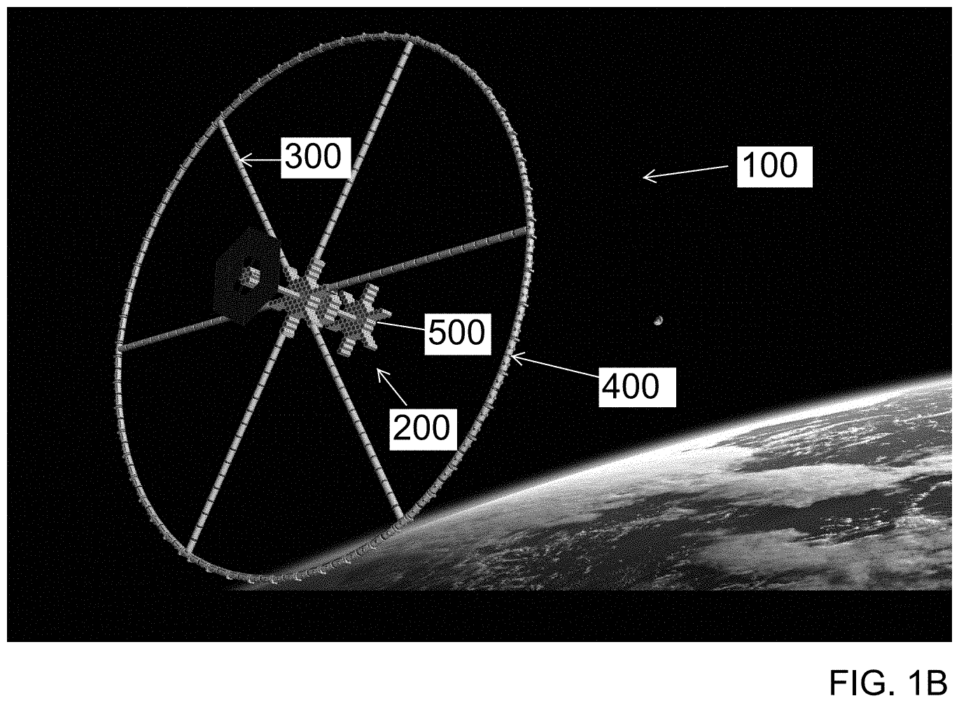

### DETAILED DESCRIPTION OF THE EMBODIMENTS

### 1. Overview

The increasing capacity of rockets leaving the Earth gives rise to the possibility of larger spacecraft that can be assembled in orbit and stay there, or then be moved to explore other planets and beyond. For the sake of this discussion, most of what is described herein focuses on an orbital space station.

In overview, a space station 100 includes a core 200 from which shafts 300 extend and connect to a ring 400. The space station 100 may also include industrial areas 500 extending from the core 200, shafts, 300, and/or ring 400.

The shafts 300, rings 400, and industrial areas 500 may be in any number, but in order to create an artificial gravity in the ring 400 (as well as any area extending out from the axis of the core 200), there would generally be a single core 200 as shown.

In order to speed production of any of the same, control costs, and allow for replacement, each of the core 200, shafts 300, and ring 400 may be constructed from a single core pod 210, shaft pod 310, and ring (or home) pod 410 respectively, along with connectors 450. While some deviation from this may be required or desired from time to time, such deviation is undesirable for reasons of cost, predictability, and replaceability. While the industrial areas 500 may also be constructed from one or more of the above pods, it is anticipated that those areas may be more specialized and require specialty pods of their own.

We turn to a discussion of the pods, and their interaction and infrastructure.

### 2. Pods

2.1 Core Pod

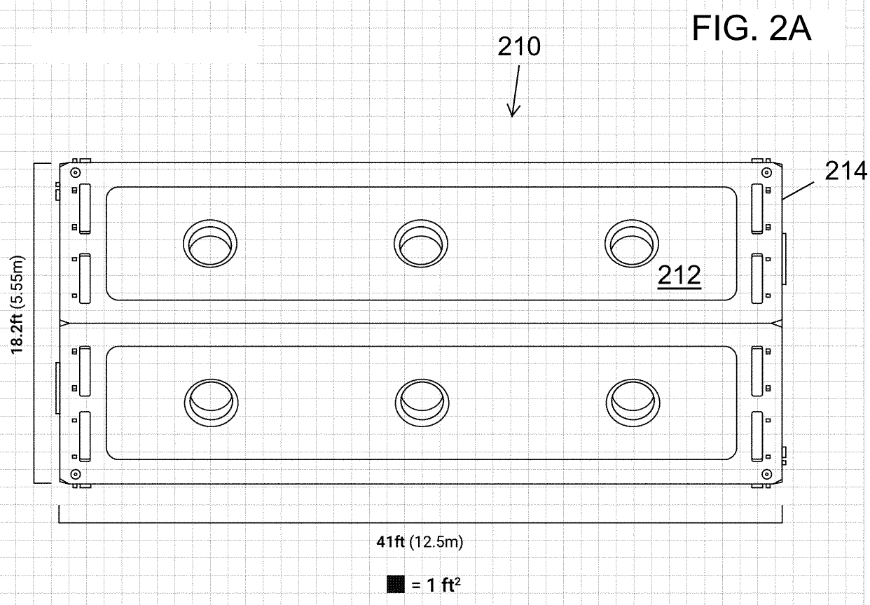

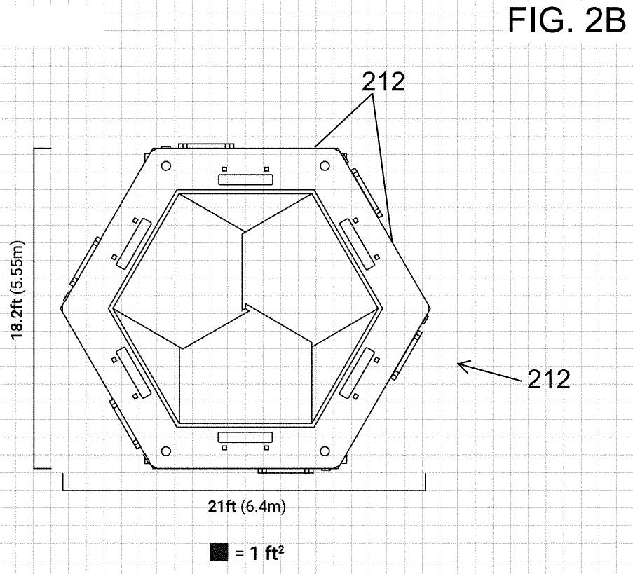

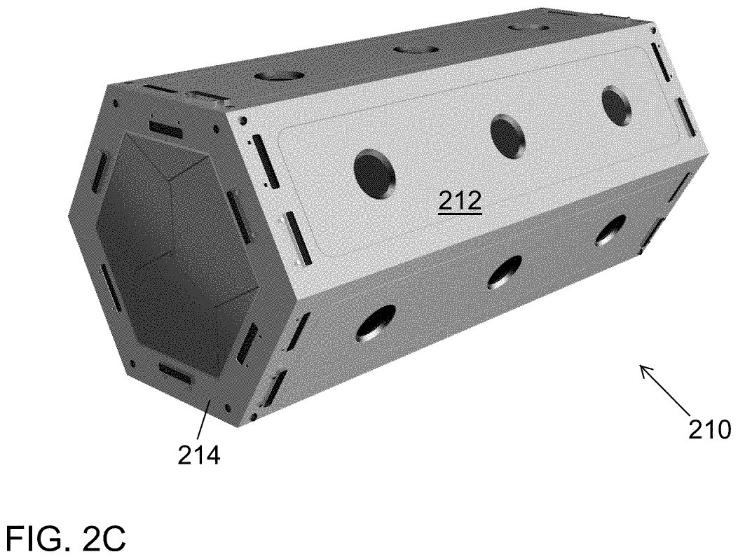

As shown in FIGS. 2A-2C, each core pod 210, while it could be cylindrical, may be hexagonal, decagonal or another 3D polygonal shape. The reason for the higher side-shapes would be to maximize their size within what would be a cylindrical payload chamber, but also present a flat side 212 for mating with the ends of shaft pods 310. The ends 214 of each core pod 210 may be resealably sealed against vacuum so that if any of the core pods 210 or shaft pods 310 are exposed to vacuum, the remaining pods are protected from same.

Each of, or some of the sides 212 may engage an end of a shaft pod 310 at a core pod port 216, which itself may be sealable to vacuum. Each of the core pods 210 may include a structure in itself or a connector for engaging to the shaft pod 310 that may include an appropriate engagement to ensure a good seal, but also a connection that is releasable. To align shafts 300 about adjacent sides, the shafts 300 may include:
a telescoping slide joint with a narrow end that engages the core pod;
a joint that extends outwards from the end 214 in a folding manner;
a joint piece 215 joins the shaft 300 to the core pod 210 at an opening 213 therein;
a hermetically sealed mating engagement (shown in shaft pods 310 at 315a, 315b) such as that shown on the ends 314a, 314b of the shaft pods 310.

One advantage of the core pod's elongated hexagonal shape would be that hexagons are capable of tessellation, that is, they can be repeated side by side to form superstructures. In some embodiments of the station 100, the core pods 200 may thus expand outwards like a beehive, in order to develop from a core-ring structure to a larger volume shape.

Core pods are designed with versatility in mind: they can be clustered to create larger open areas based on user-imagined use. For example, if a quantum computing company sought to utilize the station for computation, they would have the ability to connect two or more core pods to host web servers and other infrastructure that makes computations accessible to end users.

Each core pod may have a volume of about 7,600 cubic ft.

2.2 Shaft Pod

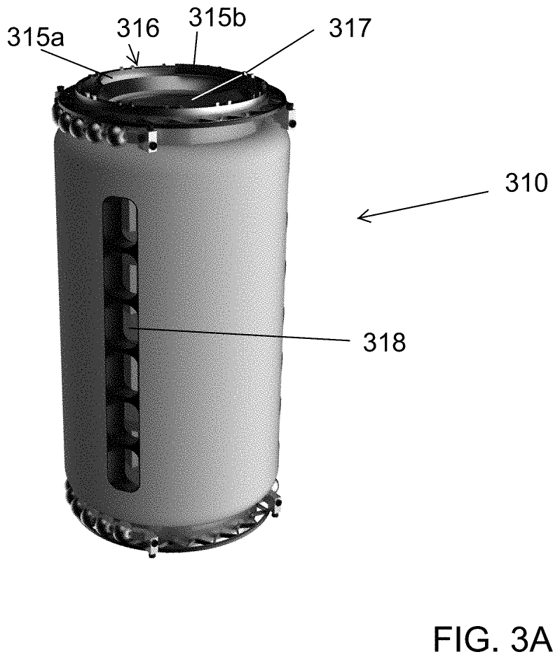

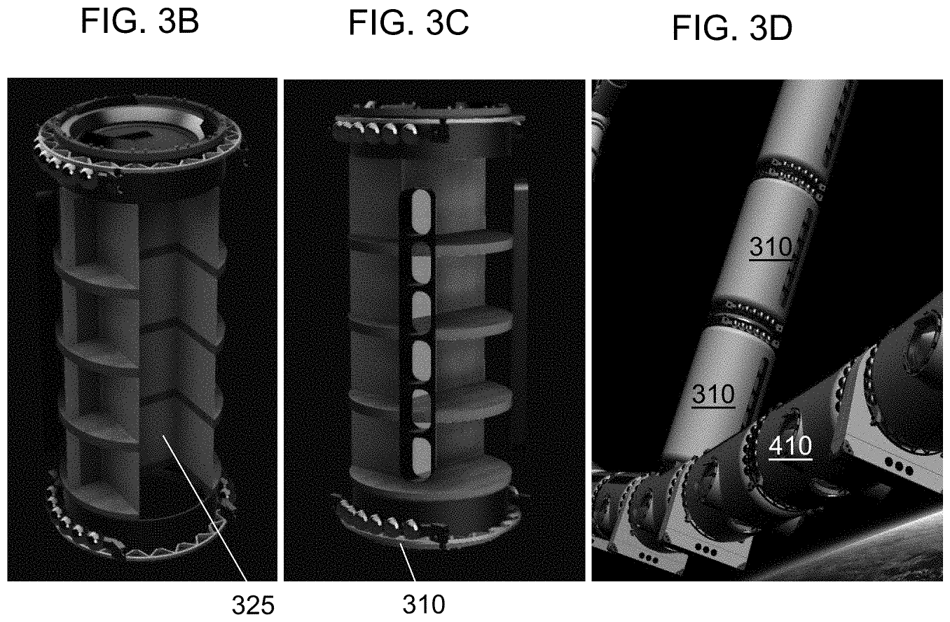

FIGS. 3A-3D show the shafts 300 that extend from the core 200 towards the ring 400. Depending on the design, the shafts 300 may extend from each side 212, or alternating sides 212. The shaft pods 310 may have mating male and female mating components 315a, 315b at their shaft pod end ports 316, and may also have ports 318 along their length for engagement with industrial pods 510 (ports 318 may be substituted for windows).

The shafts 300 and shaft pods 310 may be joined by other smaller support structures or shafts further from the core 200 to promote structural integrity or promote travel between shafts 300.

Each shaft 300 may include an elevator or other movement assistance mechanism through a shaft 325 because when the station 100 is under rotation there will be a centrifugal force to overcome when moving from the ring towards the core, and it may be helpful to receive mechanical assistance when overcoming that force.

Shaft pods may be used for a wide variety of uses due to their unique ability to experience variable levels of gravity (resultant from centrifugal forces). Their primary function may be to serve as an elevator between the low gravity core pods and the higher gravity ring pods. In use, three shafts may be dedicated to moving people, with two cars in each shaft. The other three shafts may possess larger cars meant for moving cargo.

Closer to the core, shaft pods may maintain low gravity, but due to rotation of the station, higher and potentially full-earth gravity could be artificially created at the outer edge of the shaft. The total volume of the shaft pod modules as depicted and dimensioned would be 685,480 cubic ft and this excludes the actual elevator shaft, with each shaft pod having an approximate volume of 6,700 cubic ft.

2.3 Ring Pod

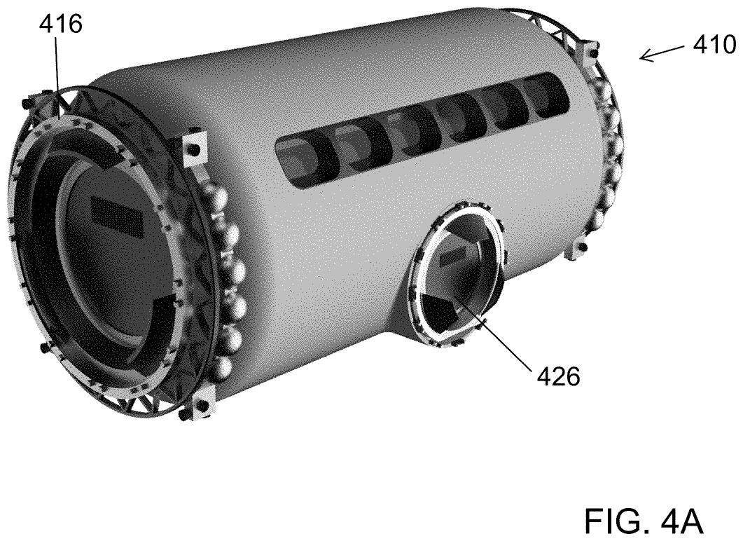

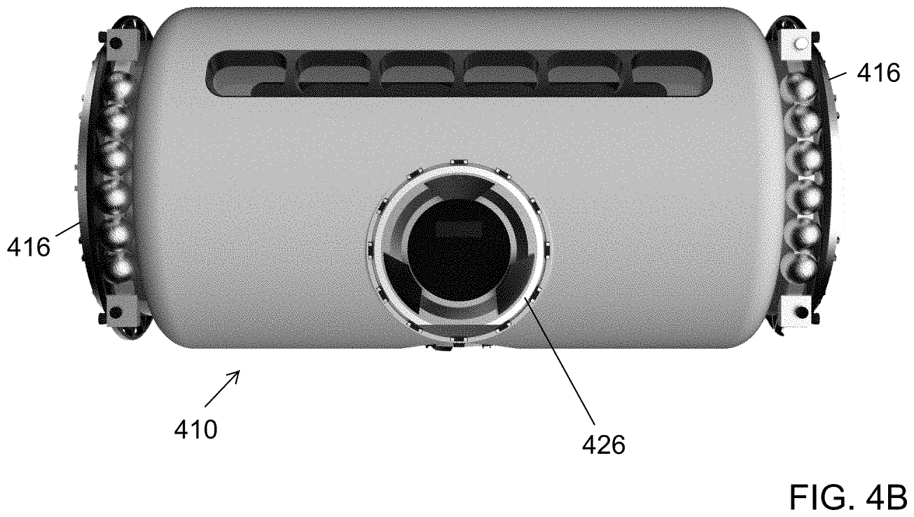

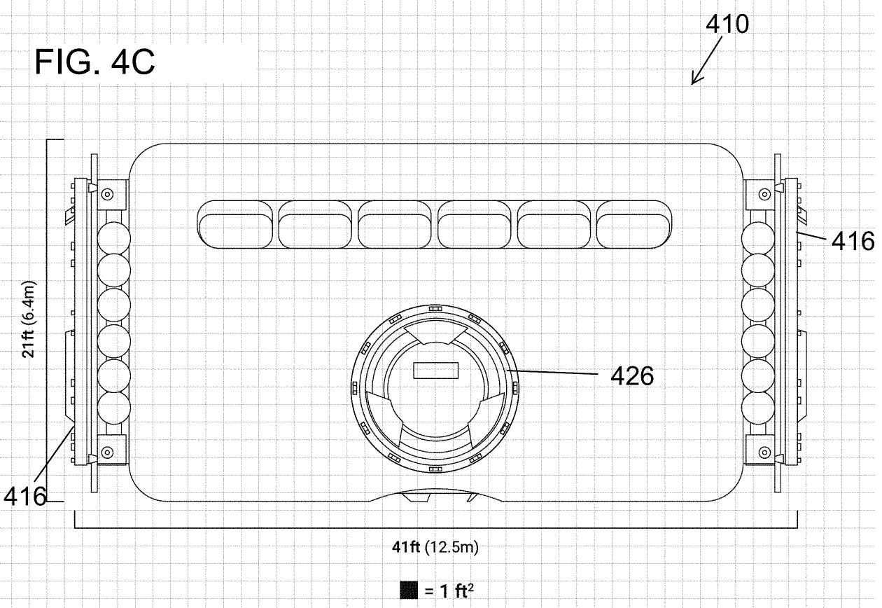

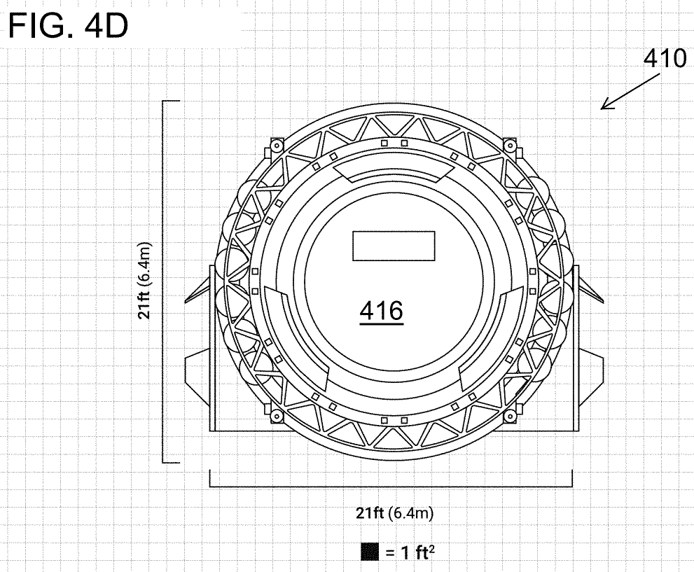

FIGS. 4A-4D show ring pods 410 where each ring or home pod 410 may have similar end structures to the shaft pods 310 with a port 416 joining adjacent pods 416 and a tongue and groove 415a, 415b mating engagement or other appropriate engagement to join adjacent pods. The ring/home pods 410 may also include a ring port 426, which would mate with another ring pod 410 in parallel, such that parallel rings can be stacked on one another. (Parallel core pods and shafts could also be stacked orthogonal to the core in order to create a generally cylindrical shaped station)

In a ring 400 with 6 shafts 300 as proposed with the hexagonal core 200, there may be a multiple of 6 home pods 410 around the core 100, with a shaft every 60 degrees.

The station 100's ring may include 120 ring pods, totaling over 1,159,659 cubic ft. as dimensioned. This amounts to an approximate volume of 9,700 cubic feet per pod, approximately 40× the volume of a standard concrete mixing truck. These outer ring pods may support residential spaces, as well as functional services like restaurants and recreation facilities.

2.4 Pod Connectors

The station 100 may include three types of connectors to join pods: ring wedges 350, shaft connectors 450, and core connectors 250.

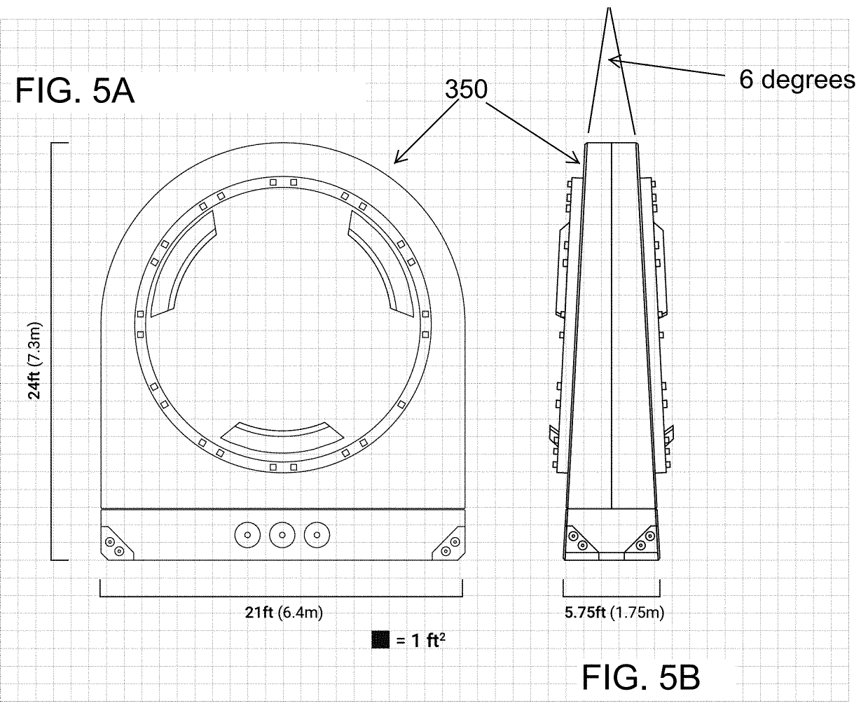

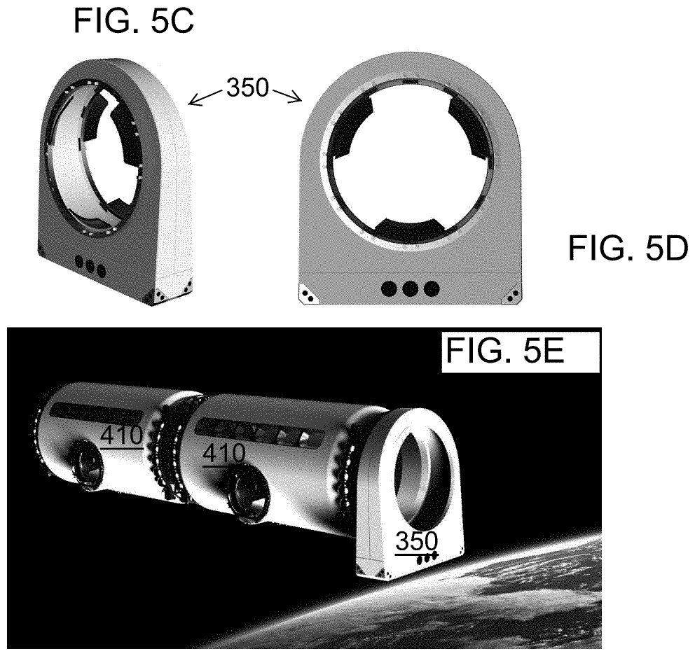

As shown in FIGS. 5A-5E, every other ring pod module may be connected by six-degree ring wedge connectors 350. These wedges serve as connections (the engagement may be a bayonet type or any engagement that results in a secure and airtight fit) but could also house thrusters similar to those found on SpaceX's Dragon Capsule. Maintaining spin for artificial gravity, as well as orbital altitude may be done using the thrusters within these wedge connectors 250 that may be refueled as needed from lines running within the walls of the ring pods 210. As contemplated. there will be 60 ring wedge connectors 350 that make up 55,911 cubic feet of the entire ring section.

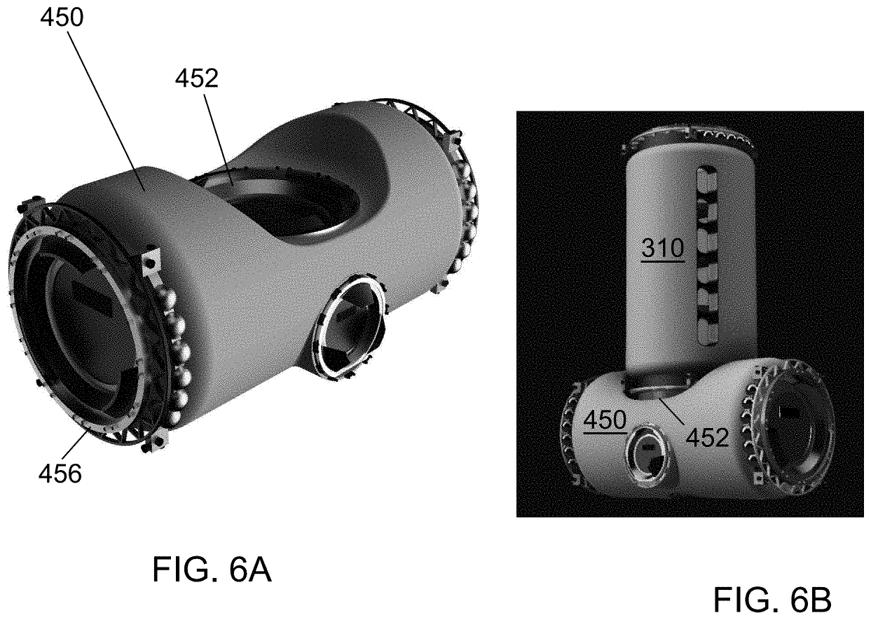

As shown in FIGS. 6A and 6B show shaft connectors 450 act as both reinforcements against the station's centrifugal force and connectors between the six shafts and the ring modules they connect to. There are 6 total shaft connector pods 450 that make up a total of 57,978 cubic feet of space around the ring 400 as shown. The shaft connectors 450 include a connection port 452 that engages the end of a shaft pod end 316. The shaft connectors 450 also include ends 456 that engage ring pod ends 416 and serve as pass through areas around the ring 400 and between the ring 400 and shafts 300.

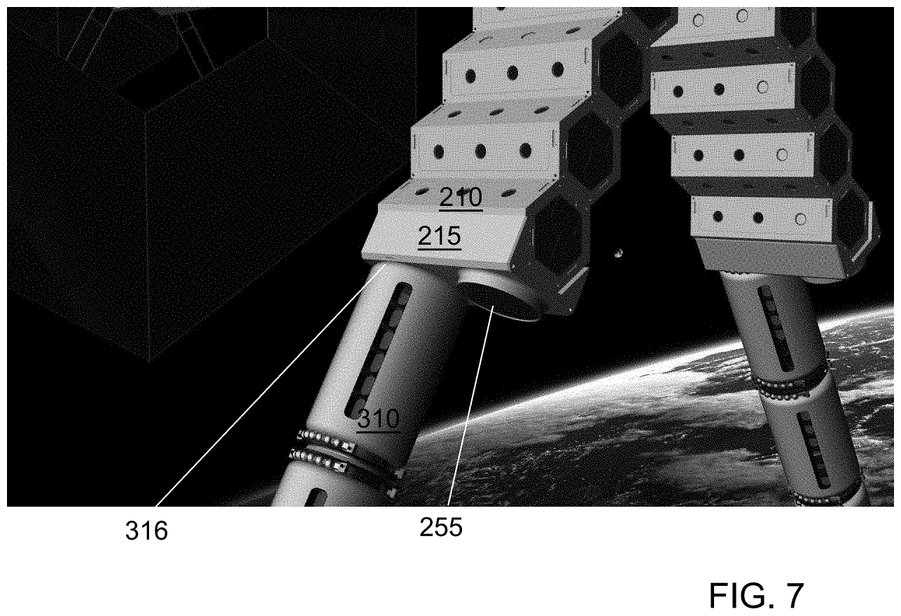

FIG. 7 shows a core connector 250 that mates the flat surface of the shaft pod end 316 to flat the hexagonal sides of the core pod 210. The core connector's objective is to not just connect the core pod cluster 200 to the six shafts 300 but to do so maximizing the size and openings 317, 255 between the two. This opening sizing could be a limiting factor for transporting things inside of and to and from the space station.

2.5 Industrial Pods

Industrial pods are not shown here in any form, as they may be in different shapes and/or custom shaped to fit specific needs. It should be anticipated, however, that like the other pods, they would be modular and join with one another in the spaces between shafts 300 and build outwards and perhaps upwards from the core towards the ring 400, or inwards from the ring 400, depending on specifications required for their use.

Although these are called industrial pods herein, the pods may be used for any purpose.

### 3. Infrastructure Misc

3.1 Introduction

In and around the core pod port 216 as well as each end of all pods, there may be infrastructure ports and joints such that infrastructure like electrical, water, waste, temperature lines connect between adjacent pods. The idea behind these infrastructure joints is that they can be sealed and opened according to the needs of the station during maintenance or emergency. When all of the pods are joined with their infrastructure, there is a shared infrastructure burden between them all such that if one area of the station 100 requires additional resources, those pods and areas that are not using resources may transfer resources to the high consumption area.

In order to create some simulation of gravity in the ring 400, the station 100 may rotate with the core 200 acting as the axis of rotation. When docking one core pod 210b to another 210c, this may prove challenging, as the new core pod 210c can only mate with the rotating core pod 210b once both pods have the same rotation. Thus, it may be necessary to use a bearing 250 during docking operations. The bearing may have two sections 252, 254 rotatable with respect to one another. During docking, as shown, the bearing rotating section 252, which may be within the core pod 210b or slightly extend therefrom, is rotating with the core 100. The second section 244 would be non-rotating in order to engage a new core pod 210c (or multiple new core pods connected in sequence). The new core pod 210c and second non-rotating section 254 would engage one another. Gradually, the second rotating section 254 would begin to rotate to match the rotation of the core 100. Once the bearing sections 252, 254 were rotating as one, the core pods 210b, 210c would engage and the bearing 250 could be withdrawn for future engagements. It should be appreciated that the bearing could be useful at the end of a series of core pods 210 in order to create a non-rotating docking platform (not shown) for receiving deliveries of pods, other supplies, people, etc.

Any pod may include view ports to the outside.

All pods would require radiation protection.

The pods are anticipated as having inner walls that are removable to access the infrastructure therethrough.

For maneuverability and joining each pod to another, the pods would have some form of propulsion on board in order to help manipulate them into position for docking. Such systems would not require mechanical arms or human intervention.

Each pod may be completely self-contained for power and life support in case of a hull breach in the station 100. In this way, batteries may be contained within pod walls, and shipped to the station 100 at full power.

Power within the station by provided by solar, nuclear, or other means.

3.2 Modularity

The space station 100 may be designed from the ground up as a true next generation space habitat. The simplicity of the modular design would allow it to grow and evolve with new technologies. By using a standardized system of parts, the station may be able to replace older sections over time, extending the lifespan of its entire ecosystem.

Individual sections of the space station may be constructed separately and uniformly. Each pod may use a standardized and replicable layout capable of adaptation to various uses. This would allow rapid pod construction and easier integration in LEO. The shared structural architecture of the pods may allow the manufacturing process to be streamlined while minimizing development costs.

3.3 Compatibility

The space station modules may house all resources and utilities internally and conveniently distribute load when connected. This creates an equal spread of demand in power and allows the space station to act as one coherent system. The distribution of load creates redundancy within the system for safety and extends the lifespan of individual components.

Single modules may be controlled through software systems that balance control, power, and life support. Similarly, higher level software hosted by the core pods may seamlessly connect the entire system of modules to control station wide functions if necessary.

3.4 Self-Sufficiency

Individual modules may be 100% self-sufficient even for non-human-supporting missions. Each module may have full life support capabilities; only requiring replenishment of food, water, and other basic human necessities to sustain occupation.

Cameras, Al, and Guidance, and Navigation Control (GNC) systems may additionally be used to automate assembly in space. Modules may use computer vision to maneuver into place and connect to the other modules as well as communicate with them enroute and on contact. This is similar to how the Dragon 2 capsule already operates and communicates with the International Space Station.

3.5 Power

The space station as a whole may use solar radiation to power life support and functional modules. Solar arrays capture energy and convert it to DC power in order to support the onboard systems. During times of low radiation, power may be drawn from onboard batteries, with hardware capable of switching between sources and distributing load.

The ISS currently has 27,000 square feet of solar panels that generate between 84 and 124 kilowatts of power every day. This installation was first “space proven,” and then finally installed in 2007 and 2008. The advancement of solar technology has steadily and rapidly grown. Efficiency as of 2014 has increased dramatically to nearly 46%.

The system herein can create an expandable solar array with Core Pods. Roughly 30,000 square feet per core pod arranged in a cluster can spread out to become a 210,000 square foot solar array and generate over 7 to 13 MW of power. This design can be further expanded as Core Pods are aggregated.

3.5 Collision Shielding

The station may use a “Whipple Shield” to protect itself from hypervelocity impact. The shield functions by breaking apart objects when hit, spreading out the force of impact across a greater surface area. The Whipple shield uses front and rear bumpers and Intermediate Resistance Layers. Improved materials provide a 17% safety improvement over the ISS shield found in Low Earth Orbit today.

3.6 Radiation Shielding

A multi-Layer Insulation (MLI) found in between layers of the station's Whipple Shield may mitigate radiation using ceramic and para-amid layers, as well as polyethylene. The MLI may be anodized in order to prevent oxygen in the space station from weakening the exterior.

Additional developments in low-hydrogen materials for the use of space infrastructure are also underway. These developments, along with natural protection from Earth's magnetic field provide multiple layers of protection.

3.7 Life Support

Space station modules may be fitted with full Environmental Control and Life Support Systems (ECLSS). Thermogenerators, air filtration systems, and water processing devices attached to each module will provide utility-scale access to basic pod infrastructure. The station can utilize extensive computational power from the space station's core, sensors distributed in each pod, and power storage to calculate and detect changes in pressure and oxygen levels. Additional improvements can be implemented on the individual pod level.

3.8 Structure and Artificial Gravity

Module weight remains a priority in order to ensure launch and agility in Low Earth Orbit. Lightweight materials may be used along with space-ready compounds for the shielding layer in order to minimize weight. The space station structure will allow for rotation and the creation of artificial gravity through centrifugal force. The structure may also include components to control altitude, vibration, and docking capability for both crew and cargo vessels.

All pods may share a similar layout and structural configuration but be reinforced depending on their uses in the station. The shared architecture may increase the longevity of the space station by allowing components to be replaced or moved from pod to pod over time. This will also allow parts to be produced at scale; driving down manufacturing costs and further streamlining assembly on the ground.

3.9 Guidance, Navigation, and Control

The station may implement GNC methodologies that allow for adjustment of both individual and connected modules. System-wide GNC may also account for constant rotation. The Command and Data Handling (CDH) subsystem of the space station will leverage the Core Pods to quickly detect changes in gravitational force and adjust accordingly. The CDH subsystem additionally may handle communication of data with external relayers such as ground control.

3.10 Software

Critical technology may be managed through an embedded systems architecture utilizing a real time operating system. This fault redundant system may be hosted on legacy hardware for use in safety and control of mission critical systems such as life support and GNC. The use of market-proven hardware components increases the reliability of key functions such as radio transmission and climate computation. Modern computer vision technology may be leveraged to aid docking and GNC systems to boost stability and success rate of missions.

Security of the software may be of importance leveraging the latest in cybersecurity, encryption and other cutting-edge technological measures. The station may house both centralized and decentralized systems for use in the case of security and or disconnection of one part of the station to the other.

Industry experts who wish to use on-board computational power can use newer hardware systems with modern software for faster data transfer and aggregation. Software may be deployable on local machines for easy connectivity, and integration of enterprise platforms may be simplified through a robust application programming interface (API).

3.11 Life Rafts

A scaled up and modified version of the Dragon Crew Capsule may be a primary mode of fast exit in case of emergency. The technology and processes demonstrated by SpaceX in their Dragon Capsule has met and exceeded the stringent requirements of all government agencies. For a station of this size, the current Dragon Capsules would need to be scaled up large enough to support the appropriate amount of people that might be accessing them.

3.12 Applications

The station is constructed such that hundreds to thousands of leasable modules will be available for enterprise use and deep space expeditions. These modules may generate revenue for the sustainable development of future infrastructure; including additional enterprise stations, docking stations, and commercial modules. Each module is designed identically, with an emphasis on infrastructure that is revenue-generating.

3.12.1 Servers

Data center energy consumption currently accounts for 1.5% of all energy produced on Earth and is expected to grow to over 14% of energy consumption by 2040. By way of comparison, the energy consumed across all houses, commercial, and retail buildings totals 10%. To put it bluntly, data centers will consume more energy than every house, apartment building, office building, shopping mall, convenience store, strip mall combined! Data Center energy drain is significant, and its corresponding climate impact is critical.

As the number of loT devices connected to the internet continues to grow from 25 billion to 75 billion, and connectivity companies like OneWeb, Starlink, Amazon and others continue to invest in infrastructure to connect the other 4-5 billion people on the planet, data centers will be completely and utterly overwhelmed. Cooling costs for a single industrial data center presently range from $55,000,000 to $88,000,000 per year.

The energy required to support them will increase exponentially and overload our grids and wallets. Getting servers onto a space station and off Earth's surface isn't just disruptive from an efficiency perspective but is a major priority for the world's energy impact.

By leveraging the free cooling available in deep space alongside the unlimited renewable energy source of the sun, servers in space will be more efficient, more economical, and longer lasting. Using radiator technology commonly found in homes and proven to work on the ISS, we have a highly cost-effective way to keep the servers at a cooler operating temperature for little to no cost compared to their Earthen counterparts.

Core layer computation modules will undergo speed reduction to limit clock speeds in the cold temperatures of the space station. Effective distribution of computational power will require fast relaying of computational hardware. Given the unique zero gravity environment of the space station, Solid State Drives must be used for storage in the core layer to avoid fatal physical errors surrounding unpredictable velocity of spinning disk drives in zero gravity conditions.

Aggregation layers receive packets and distribute data into the access layer. In order to mitigate planetary and solar radiation, an internal asynchronous timing mechanism will independently sleep entire racks by reducing packet bandwidth to near zero. Maintenance protocol is reduced in scope by preserving robust components preemptively.

Access layer connects computed and aggregated data streams for use by a public Application Programming Interface or Web User Interface. Low Orbit systems ensure consistent connectivity amidst gravitational changes affecting the space station's velocity and orientation. Customer data will initially be communicated to the ground through ku/ka band communications with plans to upgrade to laser communications as data rates demand. The modular design of the station allows for upgrades to individual systems over time and allows us to upgrade older modules to meet future standards. We are currently looking for partners with relay capabilities in orbit to maintain a consistent datastream for our customers and station telemetry.

Server racks may reside centrally in the zero-gravity environment of the core pod modules. Internal moving components required for CPU function utilize electrical charges, and thus will not be severely affected by zero gravity. The heat generated from the server units will be dissipated by fluid cooling systems that will transfer the heat from the server room to external radiator panels. The computational power will be of access to companies seeking to host software required for their space module. User-facing software will be developed in order to facilitate the deployment and integration of industry applications.

3.12.2 Fiber Optics

Fiber Optics

The data creation explosion we will experience over the coming two decades has real consequences against bandwidth as well. US Broadband providers have invested ˜$76.3B into network infrastructure over the last year, a number growing at over 3% annually. SEO satellite constellations will play a large role in this growth, causing existing infrastructure to feel the effects.

At some point, the machines that lay the fiber optic cables we have today and the companies that build the infrastructure to boost the signals won't be able to be built fast enough to satisfy our connection needs. We live in a world of abundant but not guaranteed bandwidth, especially when tripling the number of people and devices accessing the same lines.

Limits will first be felt as a result of the limitations of modern-day fiber optic glass. This glass contains impurities which require significant infrastructure to boost signals further. Even a 1% increase in purity has magnitudes of cost impact to the infrastructure required for broadband internet.

Microgravity provides a solution to the advancement of fiber optic cables. The businesses and industries around the world who currently pay for access on these information highways numbers into the trillions of dollars of global economic strength. In fact, single entities have spent upwards of $300m to shave 0.03 milliseconds off of trade time between the Chicago Mercantile Exchange and NYSE. This comes out to $362,756 per mile of fiber with an estimated installation cost of a maximum $52,400 per mile cost leaving a massive margin of profit over $300,000 per mile of fiber.

It is this type of upside that explains why companies are actively seeking even limited production of fiber optic cables manufactured in space right now. Made In Space is proving out the technology right now.

A market for more pure fiber optic cables already exists and is alive and well. What is missing from the equation is a truly scalable manufacturing facility in LEO for this product to be developed, such as the space station described herein.

3.12.3 3D Printed Organs

Current developments in bioprinting, including inkjet bioprinting and extrusion, use a scaffolding-first approach to build basic tissue structures. Organs are scaffolded using 2D layer stacking, and cells are later pipetted directly onto the structure to grow tissue. Gravity limits the effectiveness of these techniques, as cells are unable to freely connect without the use of a scaffold to hold the structure. Scaffolding lengthens the total printing time and limits the geometric complexity of the desired tissue structure. Currently, the only approved organs for transplantation are hollow structures, including the bladder and vascular tubes.

Microgravity allows for implementations of formative bioprinting techniques, which directly assemble cells into the desired structure using magnetic forces. Thus, more complex organs can be developed. On Earth, cells group flatter than they do in the human body due to gravity, but in space, they take a more natural form. Microgravity also allows for tissues to mature at faster rates than on Earth. Space printed organs can be used for examining the long-term effects of radiation on human cells, as well as transplantation of more critical systems.

Developments in space bioprinting are underway. The ISS housed the a magnetic bioprinter in 2015 that successfully printed a thyroid gland and returned to earth in january 2019. NASA plans to send a printer capable of printing beating heart tissue. On the station herein, this bioprinting technology may be expanded to scale and utilized to provide more accurate printed organs for the 100,000+US citizens on the National Organ Waiting List.

3.12.4 Nanoscale

Current manufacturing methods for carbon nanotubes are unsealable due to environmental factors that cause variability in repeated processes. Other specialized nanoscale structures like Graphene also suffer from unsealable manufacturing practice. Industry leaders have dedicated vast resources to creating the facilities required to make such material scalable, but still struggle to overcome the physical barriers created by Earth's gravity.

There are completed experiments that demonstrate efficient manufacturing of Carbon Nanotubes in low gravity environments. In the case of arc-in-water synthesis of single wall carbon nanotubes, low gravity evenly distributes temperature and boiling flow convection.

Even where gravity can't be directly cited as a cause, low gravity can be directly cited as an enabler of higher efficiency. Core Pods can be fitted for various manufacturing processes suited for nanocarbon tubes scalable manufacturing. The space station provides a framework for sustainable manufacturing of nanoscale materials with access to a low gravity laboratory environment.

3.12.5 Space Exploration

The gravity found on Earth's surface is a key barrier to the successful exploration of space. Escaping the pull of gravity to enter LEO requires 9.3-10 km/s of acceleration; while traveling from LEO to Low Mars Orbit (LMO) requires 11 km/s of acceleration. The initial escape of Earth's gravity significantly expands the amount of energy required, making LEO the ideal location for an intermediary between Earth and Deep Space.

The infrastructure on the station allows for the manufacturing of complex space vehicles capable of exploring space or maintaining parts of the station. Spacecraft constructed and launched from space station will require smaller boosters, less fuel, and provide for larger payloads to reach their destinations, lowering the cost of interplanetary and deep space exploration.

This allows for the creation of a different breed of spaceship s, without the need for large and expensive booster rockets. More efficient ships allow for agile navigation and enable the development of new tools for experimentation, mining, and communication.

### 4. Dimensioning

Although certain dimensions are shown in the figures and discussed herein, the station need not be so limited. Nevertheless, as currently shown, the following dimensions are considered.

TABLE 1
Core Pod

| | | |
|---|---|---|
| Feature | Metric | Imperial |

| | | | | |
|---|---|---|---|---|
| External Diameter | 6.4 | m | 21 | ft |
| Internal Diameter | 5.48 | m | 18 | ft |
| Internal Volume | 214.92 | m³ | 7589.82 | ft³ |
| Internal Volume without Walls | 285.44 | m³ | 10,080.17 | ft³ |
| Wall Volume | | | 415 | ft³ |
| End Port Diameter (Max) | 5.48 | m | 18 | ft |
| End Port Diameter (Min) | 3.96 | m | 13 | ft |
| Side Port Height | 2.28 | m | 7.47 | ft |
| Side Port Width | 10.9 | m | 35.75 | ft |

| | |
|---|---|
| Quantity Total (Full Station) | 162 |
| Quantity Total (Minimum | 48 |
| Station) | |
| Quantity Habitable (Full | 151 |
| Station) | |
| Quantity Habitable | 37 |
| (Minimum Station) | |

TABLE 2
Ring Pod Type A

| Feature | Metric | | Imperial | |
|---|---|---|---|---|
| External Diameter | 6.4 | m | 21 | ft |
| Internal Diameter | 5.48 | m | 18 | ft |
| Internal Volume | 267.8 | m³ | 7659.5 | ft³ |
| Bottom Floor Area | 30.25 | m² | 325.5 | ft² |
| Bottom with End Pieces Floor | | | 365.5 | ft² |
| Area | | | | |
| Bottom Floor Ceiling Height | 2.35 | m | 7.74 | ft |
| Top Floor Area | 50 | m² | 538 | ft² |
| Top with End Pieces Floor | | | 674 | ft² |
| Area | | | | |
| Top Floor Ceiling Height | 2.6 | m | 8.5 | ft |
| End Dock Diameter | 5.18 | m | 17 | ft |
| Volume of Opened End Dock | 25.38 | m³ × 2 | 896.57 | ft³ × 2 |
| Bottom Floor Area in Open | 4.14 | m² × 2 | 44.6 | ft² × 2 |
| End Dock | | | | |
| Top Floor Area in Open End | 14.85 | m² × 2 | 159.92 | ft² × 2 |
| Dock | | | | |
| Side Port Width | 2.56 | m | 8.4 | ft |
| Escape Port Diameter | 1.82 | m | 6 | ft |

| | |
|---|---|
| Quantity Total | 120 |

TABLE 3
Ring Pod Type B

| Feature | Metric | | Imperial | |
|---|---|---|---|---|
| External Diameter | 6.4 | m | 21 | ft |
| Internal Diameter | 5.48 | m | 18 | ft |
| Internal Volume | 208.36 | m³ | 7358.38 | ft³ |
| Internal Volume after | 198.36 | m³ | 7005 | ft³ |
| Elevator | | | | |
| Ramp Floor Area | 5.48 | m | 18 | ft |
| End Dock Diameter | 5.18 | m | 17 | ft |
| Volume of Opened End Dock | 25.38 | m³ × 2 | 896.57 | ft³ × 2 |
| Bottom Floor Area in Open | 4.14 | m² × 2 | 44.6 | ft² × 2 |
| End Dock | | | | |
| Top Floor Area in Open End | 14.85 | m² × 2 | 159.92 | ft² × 2 |
| Dock | | | | |
| Top Port Width | 5.18 | m | 17 | ft |
| Volume of Opened Top Port | 25.38 | m³ | 896.57 | ft³ |
| Escape Port Diameter | 1.82 | m | 6 | ft |

| | |
|---|---|
| Quantity Total | 6 |

TABLE 4
Shaft Pod

| | | |
|---|---|---|
| Feature | Metric | Imperial |

| | | | | |
|---|---|---|---|---|
| External Diameter | 6.4 | m | 21 | ft |
| Internal Diameter | 5.48 | m | 18 | ft |
| Internal Volume | 214.92 | m³ | 9,670 | ft³ |
| Internal Volume after | 190.3 | m³ | 6725.39 | ft³ |
| Elevator Shaft | | | | |
| Level 1-4 Floor Area | 16.5 | m² × 4 | 178 | ft² × 4 |
| Top Floor Area | 14.4 | m² | 155 | ft² |
| Ceiling Height | 2.35 | m | 7.33 | ft |
| End Port Diameter | 5.18 | m | 17 | ft |

| | |
|---|---|
| Quantity Total | 102 |

TABLE 5
Wedge Pod

| | | |
|---|---|---|
| Feature | Metric | Imperial |

| | | | | |
|---|---|---|---|---|
| External Diameter | 6.4 | m | 21 | ft |
| Internal Diameter | 5.18 | m | 17 | ft |
| Internal Volume | 26.38 | m³ | 931.85 | ft³ |
| Top Floor Space | | | 68 | ft² |
| Bottom Floor Space | | | 28.6 | ft² |
| End Port Diameter | 5.18 | m | 17 | ft |

| | |
|---|---|
| Quantity Total | 60 |

TABLE 7
Bearing Pod

| Feature | Metric | Imperial |
|---|---|---|
| External Diameter | 6.4 m | 21 ft |

Floor Space

Wedge Pods: 5,793.14 ft²

Shaft Pods: 88,434 ft²

Ring Pods: 130,977 ft²

Total: 225,204 ft²

Volume

Ring Section: 1,194,605.34 ft³

All Shafts w/Elevator: 986,340 ft³

All Shafts w/o Elevator: 685,991 ft³

Full Core: 1,402,585.67 ft³

Minimum Core: 308,226.29 ft³

Full Total: 3,583,531 ft³

Minimum Total: 2,489,171.6 ft³

While the invention has been described with reference to the embodiments above, a person of ordinary skill in the art would understand that various changes or modifications may be made thereto without departing from the scope of the claims.

1. A space station comprising:
a core comprising multiple connected core pods;
a ring comprising multiple connected ring pods;
at least one shaft connecting the core and the ring, the at least one shaft comprising multiple connected shaft pods;
wherein the core pods are substantially identical to one another, the ring pods are substantially identical to one another, and the shaft pods are substantially identical to one another.

2. The space station of claim 1, wherein the core pods are shaped as elongated hexagons.

3. The space station of claim 2, wherein the core pods are connected end to end to create the core.

4. The space station of claim 2, wherein the core pods are connected side to side and tessellate outwards.

5. The space station of claim 1, wherein each pod includes self-sustaining life support capability.

6. The space station of claim 1, wherein each of the core pods is releasably connectable to a shaft pod via a core connector.

7. The space station of claim 1, wherein each of the ring pods is releasable connectable to a shaft pod via a shaft connector, wherein the ring pod side provides a port that mates with an end of the shaft connector, and the shaft pod mates with the shaft connector at a shaft connector port.

8. The space station of claim 1, wherein wedge connectors join ring pods to one another.

9. The space station of claim 8, wherein the wedge pods include a form of propulsion.

10. The space station of claim 1, wherein the shaft includes an elevator or other movement assistance mechanism that overcomes a centrifugal force when moving from the ring towards the core.

11. The space station of claim 1, wherein each of the pods includes infrastructure like electrical, water, waste, temperature lines connect between adjacent pods.

12. The space station of claim 1, wherein the ring rotates about the core.

13. The space station of claim 1, further comprising a bearing with two sections that rotate one relative to another to allow for docking of new core pods or rotation of the core at a different rate to another adjacent pod.

14. The space station of claim 1, wherein each pod includes a form of propulsion.
